(19) United States
(12) Patent Application Publication
(10) Pub. No.: US 2005/0104392 A1
(43) Pub. Date: May 19, 2005

(54) Bumper system

(75) Inventors: Oliver Liebhard, Winterthur (CH); Markus Gehrig, Schaffhausen (CH); Christian Leppin, Schaffhausen (CH)

Correspondence Address: OSTROLENK FABER GERB & SOFFEN, 1180 AVENUE OF THE AMERICAS, NEW YORK, NY, 100368403, US

(73) Assignee: Alcan Technology & Management Ltd.

(21) Appl. No.: 10/976,283

(22) Filed: Oct. 28, 2004

(30) Foreign Application Priority Data
Nov. 19, 2003 (DE) 103 54 239.6
Dec. 22, 2003 (DE) 103 61 092.8
Feb. 23, 2004 (DE) 10 2004008741.5

(51) Int. Cl. B60R 19/26

(52) U.S. Cl. 293/132

(57) ABSTRACT

A bumper having crash-boxes accommodated at least in part by space in a hollow cross beam section. As a result, when impact due to collision occurs, deformation of the crash-box takes place early, so that for the same outer dimensions of the bumper longer crash-boxes can be employed. This is of advantage as the energy absorbed by the compression of the cross beam is small in relation to the mass employed and the distance traversed compared with the that achieved with crash-boxes. The capacity to absorb energy exhibited by the proposed bumper is therefore greater than that achieved by conventional bumpers.

### BACKGROUND OF THE INVENTION

The invention relates to a bumper system for attachment to a vehicle having a cross beam element and at least one deformation element, situated between the cross beam element and the vehicle, which serves to dissipate energy on collision of the vehicle.

Known bumper systems normally contain a cross beam which can be joined to, or feature, attachment means. The attachment means serve the purpose of attaching the bumper system e.g. to a vehicle. Should the vehicle collide with a solid object, the cross beam is deformed, thereby absorbing the energy of impact. The cross beams are often hollow sections, with the result that the absorption of the energy of impact is effected by compression of the hollow section perpendicular to its longitudinal direction. The cross beam is designed such that the force at which it begins to deform is lower than the force necessary to deform the vehicle structure. In the case of a minor collision, therefore, initially only the bumper is deformed with the result that only this part has to be replaced. Only when the collision is of greater magnitude are structural parts of the vehicle also deformed.

In the past, deformation elements, i.e. so called “crash-boxes”, have been proposed to increase the maximum force of impact at which there is still no deformation of the vehicle. These are situated between the cross beam or its attachment means and the vehicle (e.g. its longitudinal beams). On impact the deformation elements and the cross beam are deformed and thereby absorb the energy of impact. The deformation elements are usually in the form of hollow sections (frequently multi-chamber hollow sections), whereby their longitudinal axis lies in the direction of the longitudinal axis of the vehicle.

As a rule the known bumper systems with deformation elements are such that the cross beam, the deformation system and the vehicle structure (e.g. the longitudinal beams) are designed with respect to each other so that on impact initially only the cross beam is deformed, followed by the deformation elements and last of all deformation of the vehicle structure takes place. This was considered to be particularly advantageous with respect to repair costs as, depending on the magnitude of impact only the cross beam and deformation elements would have to be replaced.

The dimensioning of a bumper system, in particular the cross beam and the related deformation elements, is determined by the given design of the vehicle—which in the end defines the space for installation—and by the given weight. Depending on the size, weight and length of the individual elements of the bumper system in the space available for installation, this exhibits a larger or smaller capacity for absorption of energy on impact without leading to deformation of the structural parts of the vehicle itself.

If for example the space available for the bumper system in a vehicle is smaller than in previous vehicles, then the bumper system and in particular along with that also the cross beams and the deformation elements have to be re-dimensioned—which as a rule leads to a reduction in the capacity for energy absorption on impact—with the result that in some cases the bumper systems are no longer able to meet the safety test requirements for approval. On the other hand it may happen that for vehicles with unchanged space for installation of the bumper system, a bumper system with improved capacity for energy absorption has to be installed. In that case the increase in capacity for energy absorption can not normally be achieved by increasing the dimensions of previously employed bumper systems.

### SUMMARY OF THE INVENTION

The object of the present invention is to develop bumper systems further such that these are capable of absorbing a greater amount of energy on impact without an undue increase in the dimensions or weight of the vehicle fitted with the bumper system. In addition, a further developed bumper system should also be suitable for vehicles with a reduced amount of space for installation of the bumper system, this without significantly reducing the capacity for energy absorption on impact compared to conventional bumper systems. Further, the manufacture and handling of the bumper system should be very simple.

Proposed is to develop further a bumper system for attaching to a vehicle having at least one cross beam element and, situated between the cross beam element and the vehicle, at least one deformation element which serves to dissipate energy on impact, such that at least one partial region for deformation purposes of at least one deformation element projects beyond the limiting face of the cross beam element facing the vehicle.

The proposed construction is based on the knowledge that, as a result of deformation of the cross beam—in relation to the mass employed for that purpose and the distance covered—relatively little energy is absorbed. By comparison, over the same distance a deformation element absorbs significantly more energy than is the case of a cross beam. The energy density of a deformation element is therefore greater than that of the cross beam.

Further, the proposed construction is also based on the knowledge that it is possible to manufacture a bumper system that strongly absorbs energy in which it is not necessary that the cross beam has to absorb energy by plastic deformation. Rather, it is possible for the cross beam only to have the function of bending.

The proposed construction is such that the length of the deformation element is increased, in particular over the distance covered during deformation, beyond the delimiting face of the cross beam element facing the vehicle, without the outer dimensions of the bumper system having to be increased. Consequently, in the case of impact the deformation element is folded over that distance, thus producing greater absorption of energy for the same size of bumper system.

By appropriate design and dimensioning of the cross beam element and deformation element (in particular with regard to wall thickness) in the region in which the deformation element is mounted i.e. let in to the cross beam element, it is possible to realize an essentially constant reaction to force over the whole length of deformation (i.e. also outside the region of mounting). Although the whole bumper arrangement often has to be replaced as a result of impact, and in cases of very slight impact it is often not sufficient only to replace the cross beam element, the proposed bumper system can still be regarded as advantageous as it requires smaller dimensioning and therefore less material, is simpler to manufacture and the weight of the bumper system can be less.

It is of advantage if the cross beam element and/or the deformation element can, at least in some regions, be in the form of hollow sections. In the proposed case it is also possible to make use of known elements and already available production machines. For letting the deformation element into the cross beam element, it has been found to be adequate to remove an appropriate region in the rear of the cross beam element, e.g. by milling or cutting out, or by carrying out a special sloping cut e.g. by sawing, laser cutting, waterjet cutting and/or stamping. Likewise, the hollow section or sections may be extruded sections, cast sections or assembled shaped sheet parts and/or sections that are fitted on.

In particular in this connection the invention may be realized by at least some parts of at least one deformation element partly engaging in the cross beam element. The fitting in of the deformation element can be performed in a simple manner as a result of the openings created e.g. by machining, sawing, laser cutting water jet cutting and/or stamping. Additionally or independently a gripping action is also conceivable.

It is possible to construct the deformation element and/or the cross beam element out of a number of parts. That way, if desired, particular consideration can be given to the prevailing requirements.

Likewise, it may also be found to be advantageous to make the deformation element and/or the cross beam element in one piece, in particular as an extruded component. In that case the manufacture of the component in question may be particularly simple and cost favorable.

Advantageously, the deformation element and/or the cross beam element is—at least in some regions—in the form of a single chamber and/or multi-chamber hollow section. In the case of the deformation element, this is preferably a single or multi-chamber hollow section which has its profile axis running in the longitudinal direction of the vehicle and, in the case of deformation forces acting on its end faces is crushed, folding in a bellows-like manner in the longitudinal direction of the vehicle. For that reason, usefully two deformation elements are provided outside in the middle of the end regions of the cross beam element. In particular in the case of multi-chamber hollow sections, it is possible—especially in the case of deformation elements—to achieve an essentially constant force pattern during deformation of the element in question, as the proposed design avoids peak stresses in the force-distance diagram. This is to advantage as damage to the vehicle structure situated behind the impact absorption system (e.g. longitudinal beam) it is the peak stresses and not necessarily the general impact forces which are important.

According to another embodiment of the invention, at least in some regions the profile direction of the cross beam element runs essentially perpendicular to the longitudinal direction of the cross beam element. It is possible that the hollow chambers of the possibly extruded section are only open at its ends. The deformation elements may then preferably be single or multi-chamber hollow sections extruded in the longitudinal direction.

Likewise, it may prove advantageous if the profile direction of the cross beam element, at least in some regions, runs preferably essentially perpendicular to the longitudinal direction of the vehicle—and with that as a rule transverse or essentially perpendicular to the deformation elements. Thereby, it is possible that the profile direction of the cross beam element, in the form e.g. of a single or multi-chamber section, runs essentially in the longitudinal direction of the cross beam. It can, however, also be particularly advantageous when the profile direction is arranged both transverse, in particular essentially perpendicular, to the longitudinal direction of the vehicle and transverse, in particular essentially perpendicular, to the longitudinal direction of the cross beam element. Such a cross beam element may e.g. be in the form of a multi-chamber hollow section with network-like structure, which exhibits an outer face oriented towards the outside of the vehicle and an inner side face oriented towards the vehicle, whereby the chambers in the multi-chamber hollow section of the cross beam element are open towards the upper and lower faces of the section. In this version the deformation elements may usefully be single or multi-chamber hollow sections which are extruded in the longitudinal direction and extend beyond the inner side face (corresponding to the limiting face facing the vehicle) of the cross beam element and penetrate the cross beam element. In this version the recesses for insertion of the deformation elements in the cross beam element may be integral i.e. integrated by way of extrusion in the cross beam element. It is of course also possible to provide special lid elements for the upper and lower sides of the multi-chamber hollow section.

The end face of at least a part of at least one deformation element is preferably located in alignment with, i.e. abutting, the front or an inner delimiting face of the cross beam element, or in the immediate vicinity of the same. Inner delimiting faces are e.g. intermediate struts in multi-chamber sections. By means of the proposed further development it is possible to select deformation lengths that are particularly large. Additionally, it is also possible to design the means of attachment of the cross beam element and the deformation element such that this is of relatively low strength.

A connection between at least one, preferably both deformation elements and the cross beam element may be non-releasable, in particular made by riveting, welding or adhesive bonding. In this way a permanent assembly of the bumper arrangement can be realized.

It is however also possible to have at least one, preferably both deformation elements releasably attached to the cross beam element, such as in particular by means of screws. Such a releasable attachment may be useful e.g. when only the cross beam element is damaged.

It is of advantage if at least one deformation element features a trigger facility which is designed such that it reduces the initial force required to initiate the deformation procedure. This initial force i.e. the force required to initiate the folding action on impact is as a rule particularly high and therefore normally expresses itself as a particularly high peak stress in the force—distance diagram. By reducing this peak stress it is possible to reduce the probability of damage to the vehicle structure (e.g. longitudinal beam) behind the impact absorption system, because—as was already mentioned above—the maximum peak stresses are important in this respect.

The trigger facility may to advantage be made up of a partial alignment of the deformation element and cross beam element, in particular by a sporadic or linear alignment (one dimensional or two dimensional alignment). This may e.g. take place by means of an inclined end face on the deformation element (e.g. by a saw cut, milling, water jet cutting and/or stamping). The corner or corners in question usefully lie towards the middle of the cross beam since this way the free distance between both points of contact at the side is reduced and the force required to bend the cross beam between the two points of contact is increased. This can be of advantage as the cross beam within the scope of the invention is no longer necessarily conceived to take up energy, but simply and reliably to divert the forces acting on it to the deformation elements.

Likewise, it may prove advantageous for the trigger facility to feature at least in part a region which is in particular ring-shaped, groove-shaped and/or meandering in shape. This may be one or more grooves made in the side or sides of the deformation element. Feasible also is that the trigger facility comprises a ring-shaped region in the deformation element which has previously been transformed by heat treatment to a condition weaker than that of the rest of the wall regions. The ring-shaped region may lie at the part of the deformation element where folding is induced, preferably in the front end of the deformation element facing the cross beam. It is of course also possible for two or more of the above mentioned trigger facilities to be combined.

If the cross beam element exhibits an energy absorbing coating, damage to the bumper arrangement may be avoided. Also, it may be possible to improve the conduction of energy to the deformation elements. The energy absorbing coating may of course also be a layer adhesively bonded to the cross beam element. The layer or the coating may e.g. be a polymeric foam.

The bumper system is preferably made at least of metal, in particular aluminum, aluminum alloy or steel. Thereby, in particular the cross beam element or cross beam parts may be made at least in part of metal, preferably of one of the above mentioned metals. The cross beam element or the cross beam parts may, however, also at least in part be made of plastic or fiber reinforced plastic. If in the case of the cross beam or cross beam parts it concerns extruded sections or castings, then these are usefully of aluminum or an aluminum alloy. The deformation elements are usefully made out of metal, in particular aluminum or an aluminum alloy. If the bumper system or parts thereof (or the cross beam element) is/are a modular in design, then the individual components may be of different materials and/or made using different manufacturing processes.

### BRIEF DESCRIPTION OF THE DRAWINGS

Further advantages, features and details of the invention are revealed in the following description of preferred exemplified embodiments and with the aid of the drawing; these show in

FIG. 1 is a schematic perspective of a bumper system as a first exemplified embodiment of the invention in which the deformation elements are not yet inserted;

FIG. 2 is a view as shown in FIG. 1 with deformation elements inserted;

FIG. 3 schematically illustrates the connection zone in a second exemplified embodiment of the invention;

FIG. 4 schematically illustrates the connection zone of a third exemplified embodiment of the invention;

FIG. 5 schematically illustrates the connection zone of a fourth exemplified embodiment of the invention;

FIGS. 6-8 show possible multi-chamber sections for use with cross beams and/or deformation elements;

FIG. 9 shows a shape of bumper with energy absorbing coating (in plan view); and

FIG. 10 is a schematic perspective view of a further bumper system as additional exemplified embodiment of the invention with deformation elements inserted.

### DETAILED DESCRIPTION OF THE INVENTION

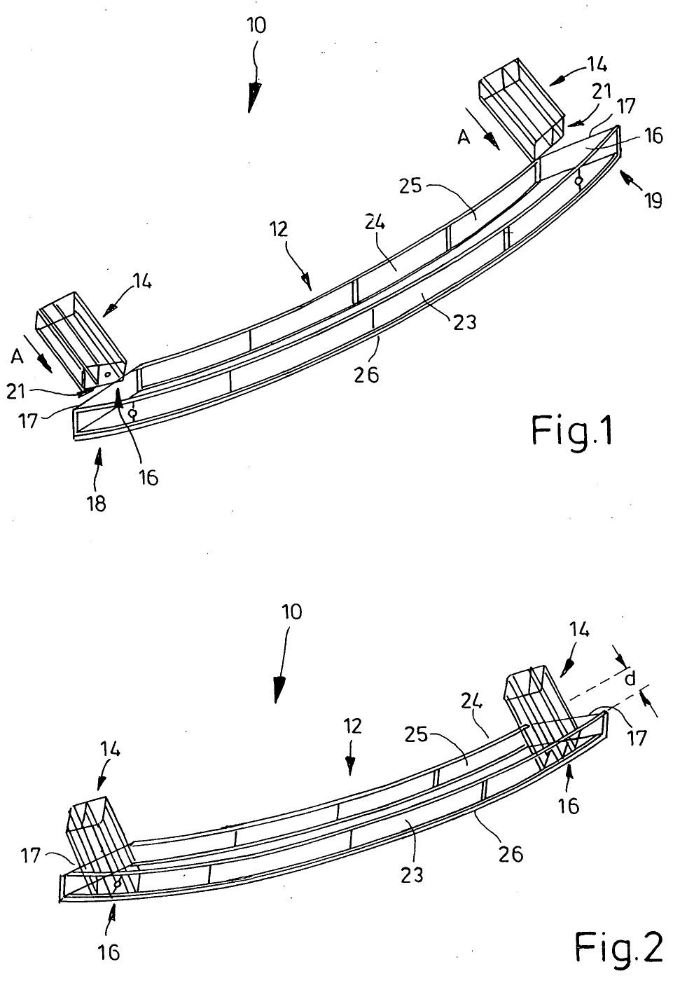

Shown in FIG. 1 is a bumper system 10 yet to be assembled. The bumper system 10 is comprised of a cross beam 12 and two crash-boxes 14 (deformation elements) which, for assembly of the finished bumper system 10, are pushed in the direction of the arrow A into appropriately shaped recesses 16 in the cross beam 12. The recesses 16 are formed in the outer ends 18 and 19 of the cross beam 12.

The vehicle, not shown here for reasons of clarity, is situated on the side of the crash-boxes 14 opposite that of the arrow A.

In the example shown, the cross beam 12 and the crash-boxes 14 are made of an extruded aluminum alloy. The cross beam 12 is in the form of a single chamber hollow section whereas the crash-boxes 14 are in the form of two-chamber hollow sections. The openings 17 through which the crash-boxes 14 are introduced into the recesses 16 are e.g. formed by an inclined saw cut or by a milling operation. The slight curvature in the cross beam 12 can be achieved by a bending operation.

Shown in FIG. 2 is the bumper system in the final assembled state. The crash-boxes 14 have been inserted via the openings 17 with their front parts in the recesses 16 formed inside the cross beam 12. The end faces 21 of the crash-boxes 14 are in line with the front side 23 of the cross beam 12. The cross beam 12 and the crash-boxes 14 are joined together to make up a unit by connecting means which are not shown here. Suitable connecting means are e.g. rivets, screws or welding or adhesive bonding.

As the crash-boxes 14 are inserted into the cross beam 12, when deformation of the bumper system 10 takes place, then deformation of the crash-boxes 14 occurs at a very early stage and with that a very pronounced dissipation of energy. In spite of the compact dimensioning of the bumper system 10, a very large amount of energy can be dissipated as the crash-boxes 14 can dissipate impact energy over their entire length. Compared with known bumper systems in which the crash-boxes are attached at the rear 24 of the bumper system 10, the additional deformation length d, essentially corresponding to the thickness of the cross beam 12, is gained.

The upper side 25 and the lower side 26 of the cross beam section 12 intersect in the region of the recesses 16 with the upper and lower sides of the crash-boxes 14. In order to prevent unnecessary peak stresses from arising in this region due to the double amount of material, it is possible e.g. to make the material thinner in this region.

Of course it would likewise be possible to remove the corresponding upper or lower sides 25, 26 of the cross beam section 12 e.g. by a milling operation. The connection between the crash-boxes 14 and cross beam 12 may then take place e.g. in the region of the end 21 of the crash-boxes 14 by means of welding.

Since with the compression of the crash-boxes 14 much more energy is absorbed in relation to the mass of material employed and the distance traversed than would be the case in which simply deformation of the cross beam 12 takes place, the proposed bumper 10 absorbs significantly more energy than known bumpers.

The cross beam 12 need not therefore be conceived with a view to absorbing energy. It must simply divert the force acting on it reliably into the crash-box 14.

Shown, schematically in plan view in FIG. 3, is a possible version of the alignment region between the cross beam 12 and the crash-box 14 at the recess 16 in the end 18 of a cross beam 12.

In the example shown, the cross beam 12 is in the form of a single chamber hollow section while the crash-box 14 is made out of a two-chamber hollow section.

As can be seen in the drawing, the inclination of the front face 23 of the cross beam 12 is smaller than the inclination of the end face 21 of the crash-box 14. Due to the different inclinations, the original state occurs only along a line of contact 28.

This construction acts as a so-called trigger which makes the initiation of folding easier. With the aid of the trigger the initial force required to initiate the folding action is reduced. As the maximum peak stresses are important with respect to damage being caused to the vehicle structure (e.g. the longitudinal beam) behind the impact absorption system, this enables deformation of the vehicle structure to be prevented.

Also the—generally known—multi-chamber form of crash-box 14 helps to avoid peak stresses.

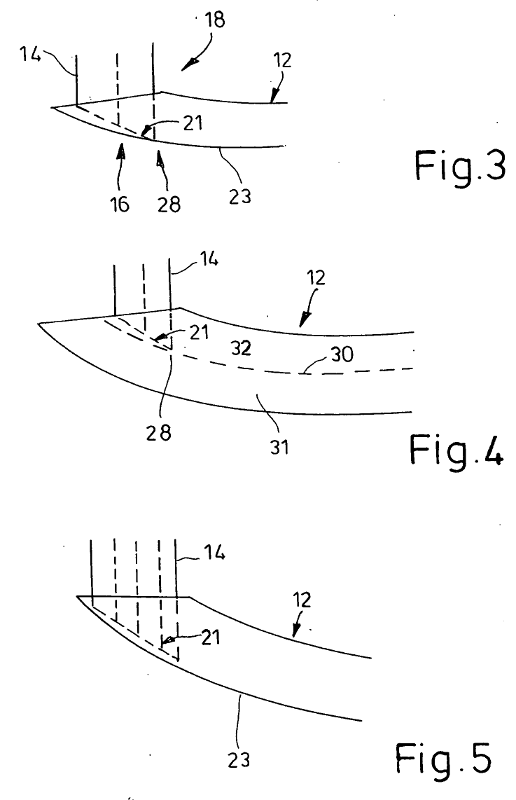

Shown in FIG. 4 is how the idea according to the invention can be applied to a cross beam 12 which is in the form of a multi-chamber section. The cross beam 12 is divided by a dividing wall 30 into a front chamber 31 and a rear chamber 32. The end wall 21 of the crash-box 14 makes contact with the dividing wall 30 in a region of contact 28.

In a situation involving a small magnitude of impact and appropriate dimensioning of the bumper system, this enables first the front chamber 31 of the transverse beam 12 to be deformed, thus dissipating energy. Only when this is no longer sufficient is the crash-box 14 deformed to dissipate energy.

With a version according to FIG. 4 it is possible to combine the advantages of conventional bumper designs and their stepwise deformation behavior with the advantages of an extended crash-box.

FIG. 5 illustrates the fact that it is of course likewise possible for the end face 21 of the crash-box 14 to be in contact with the front face 23 of the cross beam. In the example shown the peak stresses are reduced by provision of a four-chamber section.

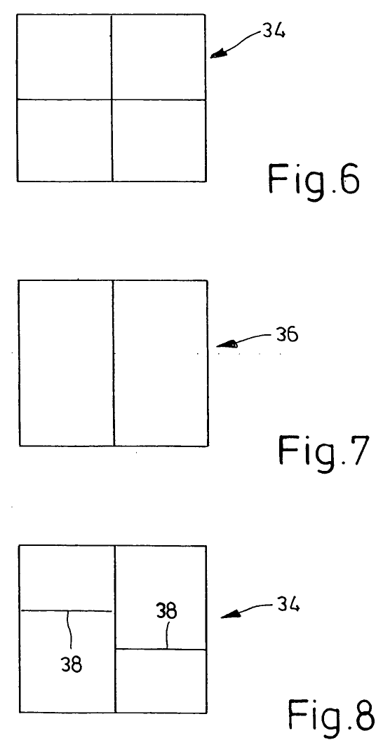

Shown simply by way of example in FIGS. 6 to 8 are possible variants of multi-chamber sections. FIG. 6 shows a four-chamber hollow section 34 and FIG. 7 a two-chamber hollow section 36. FIG. 8 also shows a four-chamber hollow section 34 whereby in this case the inner struts 38 are arranged offset with respect to each other in order to achieve better deformation behavior.

The multi-chamber sections shown here by way of example may be employed both for the crash-boxes 14 and for the cross beam 12.

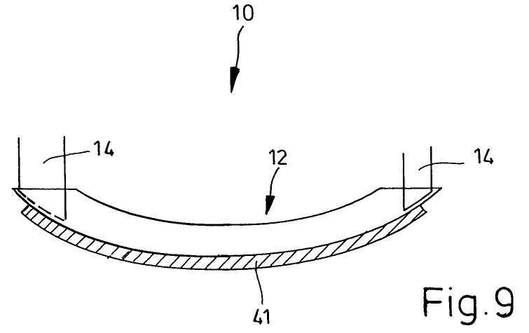

Shown In FIG. 9 is that the cross beam 12 can be provided with an energy absorbing coating 41 on the side of the bumper 10 facing away from the vehicle on the cross beam 12. The energy absorbing coating 41 may be reversible or non-reversible, e.g. a hard foam or the like. In situations involving impact of smaller magnitude the energy absorbing coating 41 can make it possible for only the cross beam 12 (with energy absorbing coating bonded onto it) to have to be replaced, while the crash-boxes 14 can be used further.

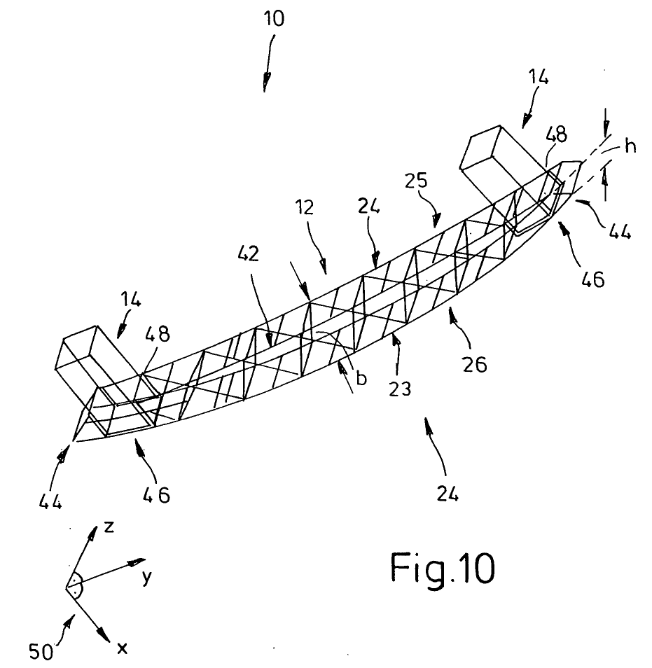

Shown in perspective view in FIG. 10 is a further possible bumper system 10 which features a cross beam 12 and attached thereto two deformation elements or crash-boxes 14. On the rear side of the crash-boxes 14 (opposite the direction of the arrow x) is the vehicle which for reasons of clarity is not shown here and onto which the bumper system 10 is mounted.

The cross beam 12 exhibits, between its front side 23 which acts as compressive strut and its rear side 24 acting as tensile strut, a network structure 42 which provides the cross beam 12 with a high degree of stiffness. At the side regions 44 are joining regions 46 where the crash-boxes 14 are joined to the cross beam 12. Also foreseen in both joining regions 46 of the cross beam 12 is a recess 48 into which a part of the corresponding crash-box 14 is introduced.

The cross beam 12 is made and arranged such that it diverts essentially all of the impact energy into the crash-boxes 14. The work of deformation of the crash-boxes 14 consumes the impact energy. As the crash-boxes 14 also extend into the recess regions 48 and with that into the cross-section of the cross beam 12, the bumper system 10 illustrated here has longer crash-boxes 14 available and therefore an extended distance for deformation. This is advantageous as, when relatively little amount of material is employed, the crash-boxes 14 exhibit a high degree of energy dissipation, which is in particular higher than the energy dissipation effected by conventional, state-of-the-art, cross beam elements.

In the present case the cross beam 12 is made of an aluminum alloy and manufactured by an extrusion process. The direction of extrusion z and therefore the longitudinal direction of the chambers formed by the network structure 42 runs in the example shown perpendicular to the longitudinal dimension y of the transverse section 12. The longitudinal axis x of the vehicle is perpendicular to both the direction of extrusion z and the longitudinal direction y of the transverse section. The directions in question are illustrated by the coordinate system 50 in FIG. 10. Thereby, x denotes the longitudinal direction of the vehicle, y the longitudinal dimension of the cross beam section and z the direction of extrusion of the cross beam 12.

Because the direction of extrusion z runs perpendicular to the longitudinal dimension of the cross beam 12, a different cross-section (e.g. breadth b of the cross beam 12) can be realized along the longitudinal direction y of the cross beam 12 during extrusion without having to perform any additional forming operations after extrusion.

The varying breadth b along the longitudinal direction y of the cross beam 12 can be easily seen in FIG. 10. Likewise the bent front face 23 and the recess regions 48 in the cross beam 14 can be achieved as in FIG. 10 without additional shaping operations after extrusion being necessary. Finally, by choice of an appropriate extrusion die, the density of struts in the network-like structure 42, the wall thickness in the front side 23, the rear side 24 or the network-like structure can be made different in different regions of the cross beam 12. Depending on how the cross beam 12 was extruded, the cross beam 12 with height h only has to be cut away from the resultant extruded section, which e.g. may be carried out by a saw cut on the upper side 25 and the lower side 26 of the cross beam.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A bumper system for attachment to a vehicle, comprising: at least one cross beam element; and at least one deformation element arranged between the cross beam element and the vehicle, said deformation element being configured to dissipate energy when the vehicle suffers impact on collision, the at least one deformation element having at least one region that extends beyond a delimiting face of the cross beam element facing the vehicle.

2. The bumper system according to claim 1, wherein the cross beam element is at least in part a hollow section.

3. The bumper system according to claim 1, wherein the deformation element is at least in part a hollow section.

4. The bumper system according to claim 1, wherein the cross beam element and the deformation element are each at least in part a hollow section.

5. The bumper system according to claim 1, wherein at least parts of the at least one deformation element penetrate the cross beam element at least in part.

6. The bumper system according to claim 1, wherein the deformation element has more than one part.

7. The bumper system according to claim 1, wherein the cross beam element has more than one part.

8. The bumper system according to claim 1, wherein the deformation element and the cross beam element each have more than one part.

9. The bumper system according to claim 1, wherein the deformation element is a single piece.

10. The bumper system according to claim 1, wherein the cross-beam element is a single piece.

11. The bumper system according to claim 9, wherein the deformation element is an extruded component.

12. The bumper system according to claim 10, wherein the cross beam element is an extruded component.

13. The bumper system according to claim 1, wherein the deformation element is at least in some regions formed as a single chamber hollow section.

14. The bumper system according to claim 1, wherein the deformation element is at least in some regions formed as a multi-chamber hollow section.

15. The bumper system according to claim 1, wherein the deformation element has a single chamber hallow section and a multi-chamber hollow section.

16. The bumper system according to claim 1, wherein the cross beam element is at least in some regions formed as a single chamber hollow section.

17. The bumper system according to claim 1, wherein the cross beam element is at least in some regions formed as a multi-chamber hollow section.

18. The bumper system according to claim 1, wherein the cross beam element has a single chamber hollow section and a multi-chamber hollow section.

19. The bumper system according to claim 2, wherein a direction of a profile (z) of the cross beam element runs, at least in some regions, transverse to a direction of a longitudinal dimension (y) of the cross beam element.

20. The bumper system according to claim 19, wherein the direction of the profile of the cross beam element runs substantially perpendicular to the direction of the longitudinal dimension of the cross beam element.

21. The bumper system according to claim 16, wherein a direction of a profile (z) of the cross beam element runs, at least in some regions, transverse to a direction of a longitudinal dimension (y) of the cross beam element.

22. The bumper system according to claim 21, wherein the direction of the profile of the cross beam element runs substantially perpendicular to the direction of the longitudinal dimension of the cross beam element.

23. The bumper system according to claim 2, wherein a direction of a profile (z) of the cross beam element runs, at least in some regions, transverse to a direction of a longitudinal axis of the vehicle.

24. The bumper system according to claim 23, wherein the direction of the profile of the cross beam element runs substantially perpendicular to the direction of the longitudinal axis of the vehicle.

25. The bumper system according to claim 16, wherein a direction of a profile (z) of the cross beam element runs, at least in some regions, transverse to a direction of a longitudinal axis of the vehicle.

26. The bumper system according to claim 25, wherein the direction of the profile of the cross beam element runs substantially perpendicular to the direction of the longitudinal axis of the vehicle.

27. The bumper system according to claim 19, wherein a direction of a profile (z) of the cross beam element runs, at least in some regions, transverse to a direction of a longitudinal axis of the vehicle.

28. The bumper system according to claim 1, wherein an end face of at least a part of the at least one deformation element is situated in at least an immediate vicinity of a front and/or an inner delimiting face of the cross beam element.

29. The bumper system according to claim 28, wherein the end face of the deformation element is situated in line with the front and/or the inner delimiting face of the cross beam element.

30. The bumper system according to claim 1, wherein the at least one deformation element is permanently joined to the cross beam element.

31. The bumper system according to claim 30, wherein the deformation element is one of riveted, welded or adhesively bonded to the cross beam element.

32. The bumper system according to claim 1, wherein two deformation elements are arranged between the cross beam element and the vehicle, both deformation elements being permanently joined to the cross beam element.

33. The bumper system according to claim 32, wherein the deformation elements are one of riveted, welded and adhesively bonded to the cross-beam element.

34. The bumper system according to claim 1, wherein the at least one deformation element is releasably joined to the cross beam element.

35. The bumper system according to claim 34, wherein the deformation element is screwed to the cross beam element.

36. The bumper system according to claim 1, wherein two deformation elements are arranged between the cross beam element and the vehicle, the two deformation elements being releasably joined to the cross beam element.

37. The bumper system according to claim 36, wherein the deformation elements are screwed to the cross beam element.

38. The bumper system according to claim 1, wherein the at least one deformation element is configured to have a trigger facility that reduces an initial force required to initiate deformation of the deformation element.

39. The bumper system according to claim 38, wherein the trigger facility is a partial alignment of the deformation element and the cross beam element.

40. The bumper system according to claim 39, wherein the trigger facility is formed by one of a point-to-point alignment or alignment along a line of the deformation element and the cross beam element.

41. The bumper system according to claim 1, wherein the trigger facility features at least in some regions at least one bent region.

42. The bumper system according to claim 41, wherein the bent region is ring-shaped, groove-shaped and/or a meandering bent region.

43. The bumper system according to claim 1, wherein the cross beam element has an energy-absorbing coating.

44. The bumper system according to claim 1, wherein the bumper system is made at least in part of metal.

45. The bumper system according to claim 44, wherein the bumper system is made at least in part of aluminum, aluminum alloy or steel.
